(19) United States
(12) Patent Application Publication
(10) Pub. No.: US 2012/0318038 A1
(43) Pub. Date: Dec. 20, 2012

(54) ULTRASOUND TRANSDUCER TEST APPARATUS AND APPLICATIONS THEREOF

(75) Inventors: MATTHEW TODD SPIGELMYER, Spring Mills, PA (US); William Robert Dreschel, State College, PA (US); Derek Ryan Greenaway, Howard, PA (US)

(73) Assignee: TransducerWorks, Centre Hall, PA (US)

(21) Appl. No.: 13/162,933

(22) Filed: Jun. 17, 2011

(51) Int. Cl. G01H 17/00

(52) U.S. Cl. 73/1.82

(57) ABSTRACT

In one aspect, testing apparatus for ultrasound transducers comprising arrays of transducing elements are described herein. In some embodiments, a test apparatus for an ultrasound transducer having a curved transducing element array comprises a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface.

### FIELD OF THE INVENTION

The present invention relates to ultrasound transducers and, in particular, to test apparatus for ultrasound transducers.

### BACKGROUND

Ultrasound imaging continues to be an effective non-destructive analytical technique for discerning structural information from a variety of materials ranging from human tissue to inorganic solids. The transmission of acoustic radiation toward a desired target can be accomplished with ultrasound transducers having various constructions. Individual transducer elements, for example, have been provided in differing arrayed formats including linear arrays, curvilinear arrays, linear phased arrays, 1.5D arrays and 2D phased arrays. Given the generally fragile nature of materials forming transducer elements, such as ceramics, the operational characteristics of transducer arrays are periodically tested to determine any functional aberrations due to damaged transducer elements or circuitry associated with transducer elements.

In some ultrasound imaging systems, internal diagnostic capabilities are available permitting limited evaluation of system operation. Such internal diagnostics, however, do not generally allow effective evaluation of acoustic transmission and receiving functions of individual transducer elements. In view of this deficiency, an ultrasound array is typically immersed in a water filled test tank with a reflector placed at a certain depth. An individual transducer element is electrically pulsed to generate an acoustic signal. The acoustic signal propagates through the water to the reflector. The acoustic signal is reflected back to the transducer element where it is converted into an electrical signal. One or more operational characteristics of the element can be derived from the electrical signal generated by receipt of the reflected acoustic signal.

Evaluating transducer elements in a water tank apparatus is a complicated and time consuming process. The transducer array, for example, must be properly aligned with the reflector along five different axes. Moreover, the water requires sufficient degassing to prevent air in the water from scattering transmitted and reflected acoustic signals. As a result of these complicated and time consuming requirements, transducer array elements are not tested as often as desired, leading to performance degradation of the array.

### SUMMARY

In one aspect, testing apparatus for ultrasound transducers comprising arrays of transducing elements are described herein. In some embodiments, a test apparatus for an ultrasound transducer having a curved transducing element array comprises a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface. In some embodiments, for example, the center of curvature of the second surface lies at the same point or substantially the same point as the center of curvature of the transducer element array when the transducer is coupled to the receiving surface.

In comprising a second surface having a center of curvature that is similar or substantially similar to the center of curvature of the transducer element array, a test block described herein, in some embodiments, permits each individual transducer element of the array to be equidistant from the acoustically reflective interface formed by the second surface and a medium.

Moreover, in some embodiments, the transducer receiving surface has a shape matching or substantially matching the shape of the transducer. In some embodiments, the transducer receiving surface has a curvature matching or substantially matching the curvature of the transducer. Additionally, in some embodiments, the center of curvature of the receiving surface is similar to or substantially similar to the center of curvature of the transducer element array.

An acoustically reflective interface can be formed between the second surface and any desired medium having an acoustic impedance mismatch with the material of the block. In some embodiments, the medium forming an acoustically reflective interface with the second surface is a fluid. In some embodiments, a suitable fluid is air. In some embodiments, a suitable fluid is water. Moreover, in some embodiments, a medium forming an acoustically reflective interface with the second surface is a solid.

In another aspect, methods of testing an ultrasound transducer are described herein. In some embodiments, a method of testing an ultrasound transducer having a curved transducing element array comprises providing a test apparatus comprising a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface. The transducer is interfaced with the receiving surface and generates an acoustic signal with one or more transducing elements of the array. The acoustic signal propagates through the block of material and is reflected at the acoustically reflective interface formed between the second surface and the medium. The reflected acoustic signal is received by one or more transducing elements of the array and converted into one or more electrical signals. In some embodiments, the electrical signals provide information regarding one or more properties of the transducing element array.

In some embodiments of methods described herein, individual transducer elements are tested to determine one or more operational or functional properties of the transducer elements. In some embodiments, for example, an individual transducer element of the array generates an acoustic signal for propagation through the block of material having a construction described herein. The acoustic signal is reflected at the interface formed between the second surface of the block and the medium. The reflected acoustic signal is received by the individual transducer element and converted to an electrical signal. In some embodiments, the electrical signal produced in response to receiving the reflected acoustic signal provides information regarding one or more properties of the transducer element.

These and other embodiments are described in greater detail in the detailed description which follows.

### BRIEF DESCRIPTION OF THE DRAWINGS

FIG. 1 is a perspective view of a test apparatus according to one embodiment described herein.

FIG. 2 illustrates pulse waveforms and corresponding frequency spectrums of individual transducer elements.

FIG. 3 illustrates sensitivity measurements of individual transducer elements of a transducer array measured in accordance with one embodiment of a method described herein.

### DETAILED DESCRIPTION

The present invention can be understood more readily by reference to the following detailed description and drawings and their previous and following descriptions. Elements, apparatus and methods of the present invention, however, are not limited to the specific embodiments presented in the detailed description and drawings. It should be recognized that these embodiments are merely illustrative of the principles of the present invention. Numerous modifications and adaptations will be readily apparent to those of skill in the art without departing from the spirit and scope of the invention.

In one aspect, testing apparatus for ultrasound transducers comprising arrays of transducing elements are described herein. In some embodiments, a test apparatus for an ultrasound transducer having a curved transducing element array comprises a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface. In some embodiments, for example, the center of curvature of the second surface lies at the same point or substantially the same point as the center of curvature of the transducer element array when the transducer is coupled to the receiving surface.

In comprising a second surface having a center of curvature that is similar or substantially similar to the center of curvature of the transducer element array, a test block described herein, in some embodiments, permits each individual transducer element of the array to be equidistant from the acoustically reflective interface formed by the second surface and a medium.

Moreover, in some embodiments, the transducer receiving surface has a shape matching or substantially matching the shape of the transducer. In some embodiments, the transducer receiving surface has a curvature matching or substantially matching the curvature of the transducer. Additionally, in some embodiments, the center of curvature of the receiving surface is similar to or substantially similar to the center of curvature of the transducer element array.

In some embodiments, a testing apparatus described herein permits facile proper alignment of the transducer element array with the acoustically reflective interface formed by the second surface and the medium. In comprising a second surface having a center of curvature matching or substantially matching the center of curvature of the transducer element array, a test block of material described herein, permits proper alignment of the transducer element array by simply interfacing the transducer with the receiving surface. This is a fundamental departure from prior water tank testing techniques requiring time consuming and complicated alignment of the transducer with a reflector over several individual axes.

Turning now to components of a test apparatus described herein, a test apparatus described herein comprises a block of material. In some embodiments, the block can be formed of any desired material. In some embodiments, the material comprises a polymeric material. A polymeric material, in some embodiments, comprises a thermoplastic, thermoset, elastomer or thermoplastic elastomer or combinations thereof. In some embodiments, a thermoplastic comprises any of the polymers provided in Table I or any combination of polymers provided in Table I.

TABLE I
Thermoplastic Test Block Materials

Polyethylene
Polypropylene
Polybutylene
Polyethylene terephthalate
Polybutlyene terephthalate
Polybutadiene
Polyacrylates (PAA, PMA, PMMA)
Polyester
Polycarbonate
Polyketone
Polystyrene
Polyamide
Polysulfones
Polyacrylonitrile
Polyvinyl chloride
Polyurethane
Polystyrene-arylonitrile
Polysiloxane
Polydimethylsiloxane

In some embodiments, a thermoset comprises epoxides, polyimides, cross-linked polyurethane(s) or cross-linked polystyrene(s) or combinations thereof. In some embodiments, an elastomer comprises any of the polymers provided in Table II or any combination of polymers provided in Table II.

TABLE II
Elastomer Test Block Materials

Styrene-1,3-butadiene (SBR)
Carboxylated SBR
Acrylonitrile-1,3-butadiene (NBR)
Isobutylene-isoprene
Polyisoprene
Polyisobutylene
Isoprene-styrene block Copolymer
1,3-butadiene-sytrene Copolymer
Polychloroprene

In some embodiments, the block of a test apparatus described herein is formed from a metal or alloy. In some embodiments, a metal comprises a transition metal. In some embodiments, for example, a metal comprises copper, nickel, iron or titanium. A metal, in some embodiments, comprises aluminum.

In some embodiments, a material for the test block is selected according to the acoustic attenuation characteristics of the material. In some embodiments, a material for the test block does not significantly attenuate acoustic signals traveling through the block. In some embodiments, for example, a material of the test block does not attenuate or reduce acoustic signals to values marginally above system noise used to evaluate the acoustic signals.

In some embodiments, a material for the test block is selected with reference to one or more materials intended to be analyzed by the transducer array. In some embodiments, for example, a transducer is suitable for imaging human tissue in one or more medical applications. As a result, a material for the test block having a velocity of sound similar to the type(s) of tissue to be analyzed by the transducer array can be selected for the test block. In some embodiments, a material for a test block described herein can have a velocity of sound equal to or approximately equal to the values of Table III.

TABLE III
Velocity of Sound (m/sec.)
1450
1480
1540
1550
1560
1570
1580
1600
1620
1900
2400
2600
3200
4080
4700
5200
5900
6100
6300
9900

In some embodiments, a material used to provide a block of a testing apparatus described herein is uniform or substantially uniform in nature. In some embodiments, the material does not comprise inhomogeneities and/or species operable to scatter acoustic signals. In some embodiments, for example, the material is monolithic and does not comprise particles, air pockets and/or other discontinuities in the material bulk or at the surface operable to scatter acoustic signals. Additionally, in some embodiments, the transducer receiving surface and/or second surface of the material is polished.

As described herein, reflection of an acoustic signal generated by the transducer occurs at the acoustically reflective interface formed by the second surface and a medium. An acoustically reflective interface can be formed between the second surface and any desired medium having an acoustic impedance mismatch with the material of the block. In some embodiments, the medium forming an acoustically reflective interface with the second surface is a fluid. In some embodiments, a suitable fluid is air. In some embodiments, a suitable fluid is water or aqueous based liquid. In some embodiments, a suitable fluid is an organic liquid.

Moreover, in some embodiments, a medium forming an acoustically reflective interface with the second surface is a solid. In some embodiments, a solid layer having an acoustic impedance mismatch is coupled to the second surface, thereby forming the acoustically reflective interface. In some embodiments, for example, the second surface is constructed of a polymeric material, and a metal film or layer is coupled to or deposited on the polymeric second surface to form the acoustically reflective interface of the test apparatus.

In some embodiments, the acoustically reflective interface can have any desired coefficient of reflection based on selection of the material forming the test block and selection of the medium in contact with the second surface of the block. In some embodiments, the acoustically reflective interface has a coefficient of reflection of at least 0.8. In some embodiments, the acoustically reflective interface has a coefficient of reflection of at least 0.9 or 0.95. In some embodiments, the acoustically reflective interface has a coefficient of reflection of 0.98 or 0.99. The acoustically reflective interface, in some embodiments, has a coefficient of reflection of 1.

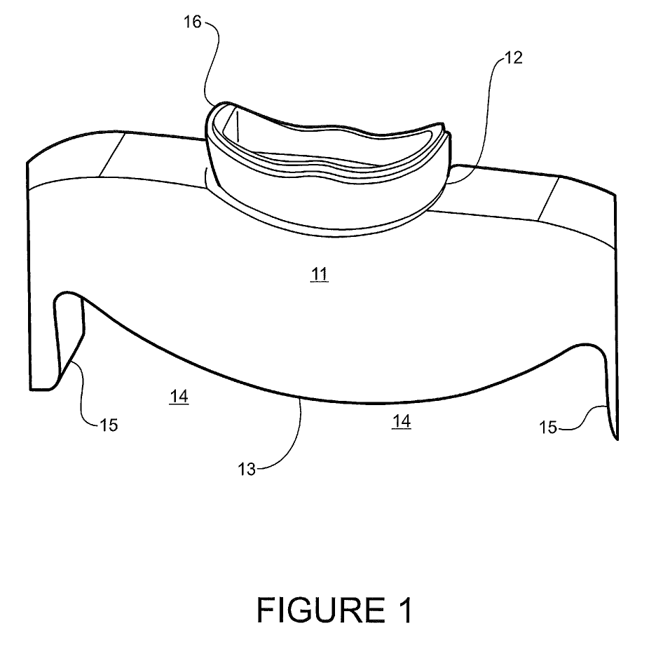

FIG. 1 illustrates a perspective view of a test apparatus according to one embodiment described herein. As illustrated in FIG. 1, the test apparatus (10) comprises a block of material (11) comprising an ultrasound transducer receiving surface (12) and a second surface (13) in facing opposition to the receiving surface (12) and forming an acoustically reflective interface with a medium (14). In the embodiment of FIG. 1, the medium (14) is air as the block of material (11) further comprises legs (15) for positioning the second surface (13) above a surface on which the legs (15) are placed. Additionally, in the embodiment of FIG. 1, an ultrasound transducer (16) comprising a curved transducing element array is illustrated interfacing with the receiving surface (12). The shape of the receiving surface (12) matches or substantially matches the shape of the transducer (16).

In some embodiments, curved transducing element arrays suitable for use with a testing apparatus described herein can comprises a variety of constructions including linear arrays, linear phased arrays, 1.5D arrays and 2D phased arrays.

In some embodiments, test apparatus described herein can be produced according to several methods. In some embodiments, a test apparatus is provided by forming the block of material in a mold having the desired curvature for the transducer receiving surface and the second surface. Alternatively, in some embodiments, a test apparatus is provided by milling a monolithic piece of material to provide a transducer receiving surface and second surface of desired curvature.

In another aspect, methods of testing an ultrasound transducer are described herein. In some embodiments, a method of testing an ultrasound transducer having a curved transducing element array comprises providing a test apparatus described herein comprising a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface. The transducer is interfaced with the receiving surface and generates an acoustic signal with one or more transducing elements of the array. The acoustic signal propagates through the block of material and is reflected at the acoustically reflective interface formed between the second surface and the medium. The reflected acoustic signal is received by one or more transducing elements of the array and converted into one or more electrical signals. In some embodiments, the electrical signals provide information regarding one or more properties of the transducing element array.

In some embodiments of methods described herein, individual transducer elements are tested to determine one or more operational or functional properties of the transducer elements. In some embodiments, for example, an individual transducer element of the array generates an acoustic signal for propagation through the block of material having a construction described herein. The acoustic signal is reflected at the interface formed between the second surface of the block and the medium. The reflected acoustic signal is received by the individual transducer element and converted to an electrical signal. In some embodiments, the electrical signal produced in response to receiving the reflected acoustic signal provides information regarding one or more properties of the transducer element.

In some embodiments of methods described herein, individual transducing elements of an array are tested sequentially or serially. In some embodiments, an acoustic signal is generated by a first single transducing element. The acoustic signal propagates through the material of a test apparatus described herein and is reflected at the acoustically reflective interface formed by the second surface and the medium. The reflected acoustic signal is received by the first single transducing element and converted into an electrical signal. An acoustic signal is subsequently generated by a second single transducing element and propagated through the material of the test apparatus. The acoustic signal is reflected at the acoustically reflective interface formed by the second surface and the medium. The reflected acoustic signal is received by the second single transducing element and converted into an electrical signal.

Alternatively, in some embodiments, individual transducing elements are tested simultaneously as one or more subsets of the array.

In embodiments of methods described herein, a suitable acoustic coupling medium is used to interface the transducer to the test block apparatus.

In some embodiments, test apparatus described herein can be used with an ultrasound transducer interfaced with additional testing equipment for providing transducing element interrogation signals and processing electrical signals generated by conversion of reflected acoustic signals, such as equipment described in U.S. Pat. No. 7,007,539, which is hereby incorporated by reference in its entirety. In some embodiments, test apparatus described herein can be used with a transducer interfaced with ultrasound imaging system. In some embodiments wherein the transducer is interfaced with an ultrasound imaging system, testing of the transducing element array according to a method described herein produces a line image wherein inconsistencies in brightness along the line indicate transducing element degradation.

Embodiments of compositions and methods described herein are further illustrated by the following non-limiting example.

### Example 1

### Ultrasound Transducer Test Apparatus

A test apparatus, according to one embodiment described herein, comprising a transducer receiving surface and second surface having a center of curvature matching or substantially matching the center of curvature of the 128 element array of an Acuson 4C1 ultrasound transducer when coupled to the transducer was milled out of a cross-linked polystyrene available from C-Lec Plastics under the trade designation Rexolite 1422 on a Haas Model VF1CNC milling machine commercially available from Haas Automation, Inc. of Oxnard, Calif.

The Acuson 4C1 transducer was coupled to a FirstCall aPerio transducer testing system commercially available from Unisyn Medical Technologies of Golden, Colo. The curved patient side face of the Acuson 4C1 transducer was received by the receiving surface of the milled test apparatus, and individual elements of the transducer were tested, wherein the interface formed by the second surface of the milled test apparatus and air served to reflect acoustic signals generated by each transducing element of the array.

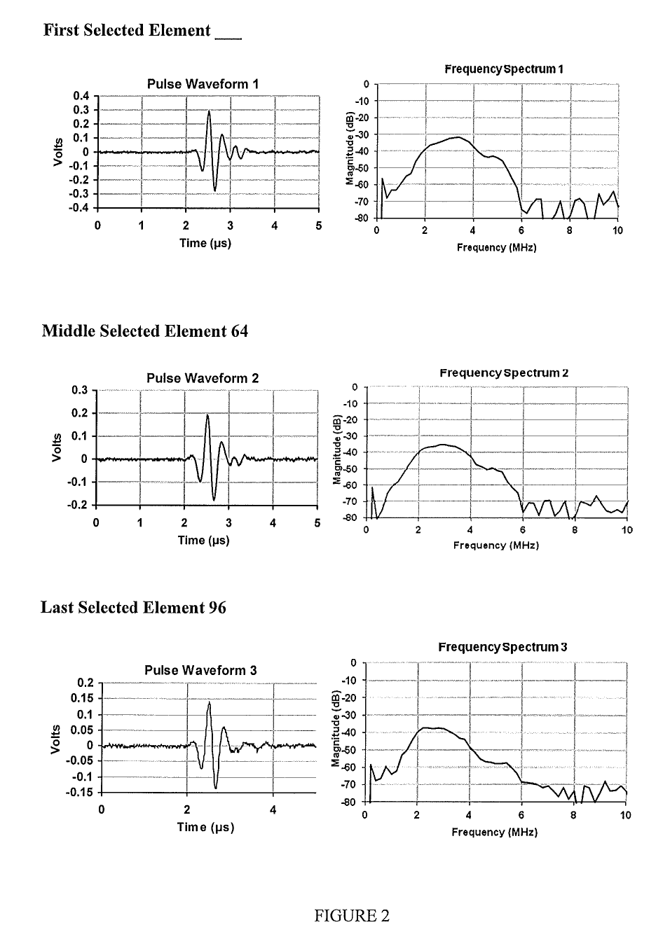

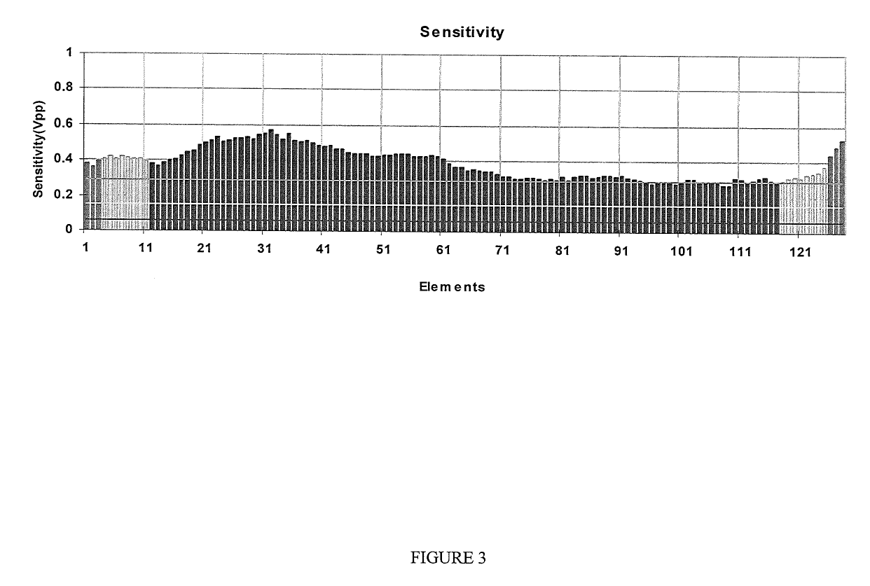

FIG. 2 illustrates pulse waveforms and corresponding frequency spectrums of several individual transducer elements tested. Moreover, FIG. 3 illustrates the sensitivity of each of the 128 transducer elements as measured by the testing. The sensitivity measurements resulting from the testing indicated that the test apparatus of the present example provided sufficient acoustic signal propagation and reflection characteristics to permit effective evaluation of transducer element arrays.

Various embodiments of the invention have been described in fulfillment of the various objectives of the invention. It should be recognized that these embodiments are merely illustrative of the principles of the present invention. Numerous modifications and adaptations thereof will be readily apparent to those of skill in the art without departing from the spirit and scope of the invention.

That which is claimed is:

1. A test apparatus for an ultrasound transducer comprising a curved array of transducing elements having a center of curvature, the apparatus comprising:
a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface.

2. The test apparatus of claim 1, wherein the receiving surface has a center of curvature similar to or substantially similar to the center of curvature of the transducer element array.

3. The test apparatus of claim 1, wherein the medium is a fluid.

4. The test apparatus of claim 3, wherein the fluid is air.

5. The test apparatus of claim 3, wherein the fluid is water.

6. The test apparatus of claim 1, wherein the medium is a solid.

7. The test apparatus of claim 1, wherein the material is a polymeric material.

8. The test apparatus of claim 7, wherein the polymeric material comprises a thermoplastic or a thermoset.

9. The test apparatus of claim 7, wherein the polymeric material comprises an elastomer or a thermoplastic elastomer.

10. The apparatus of claim 1, wherein the material comprises a metal.

11. The test apparatus of claim 1, wherein the material has a velocity of sound approximating a velocity of sound of a material to be analyzed by the ultrasound transducer.

12. The test apparatus of claim 11, wherein the material to be analyzed is human tissue.

13. The test apparatus of claim 1, wherein the curved array of transducing elements is a linear array, a 1.5D array or a 2D array.

14. A method of testing an ultrasound transducer comprising a curved array of transducing elements having a center of curvature, the method comprising:
providing a test apparatus comprising a block of material permitting propagation of an acoustic signal generated by the transducer, the block of material comprising a transducer receiving surface and a second surface in facing opposition to the receiving surface and forming an acoustically reflective interface with a medium, the second surface comprising a curvature having a center similar to or substantially similar to the center of curvature of the transducer element array when the transducer is coupled to the receiving surface;
interfacing the transducer array with the receiving surface of the block of material;
generating an acoustic signal with the transducer array;
propagating the acoustic signal through the block of material; and
reflecting the acoustic signal at the acoustically reflective interface.

15. The method of claim 14, further comprising receiving the reflected acoustic signal with one or more of the transducing elements of the array and converting the received acoustic signal into one or more electrical signals.

16. The method of claim 14, wherein the acoustic signal is generated by a first single transducing element of the array.

17. The method of claim 16 further comprising receiving the reflected acoustic signal with the first single transducing element and converting the received acoustic signal into an electrical signal.

18. The method of claim 17, wherein the electrical signal provides information regarding one or more properties of the first single transducing element.

19. The method of claim 17 further comprising generating an additional acoustic signal with a second single transducing element, propagating the acoustic signal through the block of material and reflecting the acoustic signal at the reflective interface.

20. The method of claim 19 further comprising receiving the reflected acoustic signal with the second single transducing element and converting the received acoustic signal into an electrical signal.

21. The method of claim 20, wherein the electrical signal provides information regarding one or more properties of the second single transducing element.
